(19) United States
(12) Patent Application Publication
(10) Pub. No.: US 2006/0008216 A1
(43) Pub. Date: Jan. 12, 2006

(54) Device for signal transmission between two terminals

(76) Inventors: Peter Zamzow, Bochum (DE); Helmut Steinberg, Stornstein (DE); Josef Krauthan, Tirschenreuth (DE)

Correspondence Address: SOFER & HAROUN, L.L.P.;Suite 910, 317 Madison Avenue, New York, NY, 10017, US

(21) Appl. No.: 11/153,916

(22) Filed: Jun. 15, 2005

(30) Foreign Application Priority Data
Jul. 9, 2004 (DE) 10 2004 033 024.7

(51) Int. Cl. G02B 6/44

(52) U.S. Cl. 385/114; 385/135

(57) ABSTRACT

A device for signal transmission includes two terminals, between which a flat ribbon line (10) is arranged, which runs in turns, forms a winding body, is housed in an essentially circular cassette, and has at least two parallel, spaced conductors (15) embedded in a sheath (16) made of insulating material. The cassette consists of a rotor that can rotate about the axis of the cassette, on which rotor one of the terminals is attached, and of a stationary stator, on which the other terminal is attached. The winding body of the flat ribbon line is arranged between the stator and rotor. To reduce the sliding friction between the flat ribbon line (10) and the plastic parts of the cassette, the sheath (16) of the flat ribbon line (10) is covered all the way around and over its entire length by a thin layer (17) of a cross-linked insulating material with very good antifriction properties.

### RELATED APPLICATION

This application is related to and claims the benefit of priority from German Patent Application No. 10 2004 033 024.7, filed on Jul. 9, 2004, the entirety of which is incorporated herein by reference.

### FIELD OF THE INVENTION

The invention concerns a device for signal transmission between two terminals.

### BACKGROUND OF THE INVENTION

Prior art systems such as those disclosed in DE 295 10 286, concern a device for signal transmission between two terminals, between which a flat ribbon line is arranged, which runs in turns, forms a winding body, is housed in an essentially circular cassette, and has at least two parallel, spaced conductors embedded in a sheath made of insulating material, which conductors can be connected to continuing lines at the two terminals and whose length is significantly greater than the distance between the two terminals, and in which device the cassette consists of a rotor that can rotate about the axis of the cassette, on which rotor one of the terminals is attached, and of a stationary stator, on which the other terminal is attached, between which the winding body of the flat ribbon line is arranged.

A device of this type is needed, for example, for transmitting a signal to trigger an airbag of a collision protection system of a motor vehicle. It is housed in the steering wheel of a motor vehicle to transmit an electrical or optical signal. Accordingly, the term “line” in the context of the invention can refer to an electrical or an optical line. With a device of this type, current and/or signal transmission between stationary and moving parts of the motor vehicle can occur without sliding contacts or slip rings.

EP 0 417 350 A and the aforementioned DE 295 10 286 U, for example, disclose devices for contactless current transmission, for example, by means of a flat ribbon line wound into a winding body in the manner of a spring barrel. Hereinafter, a flat ribbon line will be abbreviated “FRL”. When a relative movement of the two terminals connected by the FRL occurs, the wound FRL “breathes” (expands and contracts) like the spring of a watch. The turns of the wound FRL contract to a smaller diameter in one direction of rotation and expand back to a larger diameter in the other direction of rotation. EP 0 735 631 B describes a similar device, in which, however, the winding body is split up into two partial windings with opposite winding directions, between which a ring-shaped guide element is arranged. The inversion point between the partial windings engages in the guide element, which, during a rotational movement of the rotor, is carried along in the circumferential direction of the cassette by the partial windings, whose diameters are changing. In this regard, the surface of the guide element is designed in such a way that the smallest possible contact surfaces with the parts of the adjoining partial windings are obtained, so that the guide element is prevented from getting stuck, especially with the inner partial winding. In both embodiments of the device, the turns of the FRL slide on the adjoining surfaces of the stator and rotor when the steering wheel of a vehicle equipped with the device is turned. The same is also true of the guide element. Annoying noises with these devices due to this alone as well as to vibrations during travel often cannot be avoided.

In the device disclosed in EP 0 417 350 A, to reduce noises of this type at least to a level that is not annoying, the surfaces along which the FRL slides are covered with a layer of a textile insulating material. It cannot be ruled out that the movement of the FRL is hindered by the two layers due to variable tolerances and due to the fibrous surface of the insulating materials.

This danger is for the most part prevented in the device disclosed in DE 295 10 286 U. In this device, one of the two surfaces is provided with a felt-like layer that is composed of fibers and has a smooth surface, while a layer of foamed plastic with a closed flat surface is applied on the opposite surface.

### OBJECTS AND SUMMARY OF THE INVENTION

The objective of the invention is to provide a simple means of preventing the occurrence of noise in the aforementioned device and to ensure unhindered movement of a guide element present in a cassette of the device.

In accordance with the invention, this objective is achieved by surrounding the covering of the FRL along its entire length and all around with a thin layer of a crosslinked insulating material that has very good antifriction properties, so that the sliding friction between the FRL and the plastic parts of the cassette is minimized.

Finally, in the same operation as its production or subsequently, this FRL is completely embedded in a thin coating of a material that has very good antifriction properties or good sliding ability. Even though this coating is very thin, it is closed all the way around. Furthermore, after it has been crosslinked, this material is sufficiently stable. The sliding friction between the FRL and the surfaces of the rotor and/or stator of the device and the guide element that is possibly present is reduced to a minimum by this material. As a result, the FRL slides so smoothly along the adjoining surfaces of the rotor and stator that this movement can hardly be heard anymore. Noises that might disturb the driver of the vehicle are avoided in this way without the use of insulating layers. Slight sliding noises that possibly cannot be completely eliminated do not reach the ear of the driver but rather are completely contained by the closed cassette and the parts of the steering wheel that surround it. In the case of the embodiment of the cassette with a guide element, the good antifriction material ensures that the partial windings, especially the inner partial winding, can largely be prevented from becoming stuck with the guide element. As a result, the guide element can have a much simpler design. This is especially true of its surfaces that face the partial windings.

### BRIEF DESCRIPTION OF THE DRAWINGS

Embodiments of the object of the invention are illustrated in the drawings.

FIG. 1 shows a schematic view of a cassette with a device in accordance with the invention.

FIG. 2 shows an embodiment of the cassette that is modified from the cassette shown in FIG. 1.

FIG. 3 shows a top view of an FRL that can be used in the device with layers removed in steps.

FIG. 4 shows a section through FIG. 3 along line IV-IV in an enlarged view.

### DETAILED DESCRIPTION

The invention is described below for a cassette, which is also representative of other embodiments, in which a flat ribbon line (FRL) with electrical conductors is installed. However, instead of the FRL, it would also be possible to use a line with at least one optical waveguide. A combination line with electrical and optical conductors could also be used.

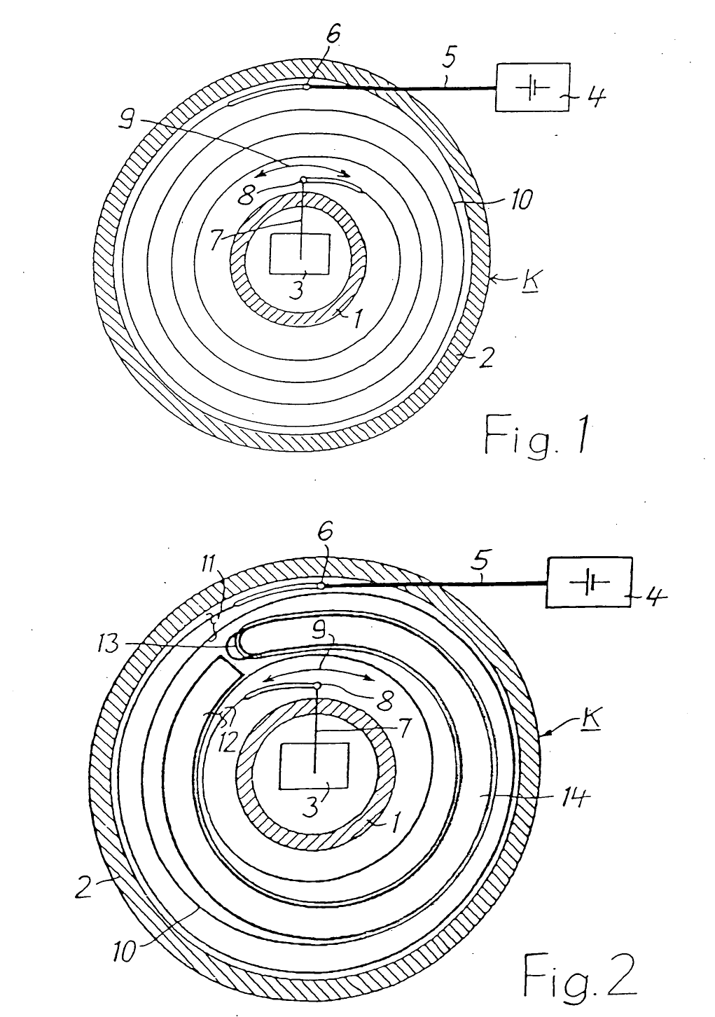

FIG. 1 shows a schematic representation of two, e.g., circularly formed, walls 1 and 2 of a plastic cassette K. Examples of suitable plastics are polycarbonate, polyoxymethylene, and polybutylene terephthalate. The wall 1 belongs, for example, to a rotor of the cassette K that can be rotated about its axis, while the wall 2 then belongs to its stationary stator. However, the assignment of the walls could also be reversed. The cassette K is intended for installation in the steering wheel of a motor vehicle. The cassette K is connected to the battery 4 of the motor vehicle to supply power to an electronic device 3, whose signal can trigger an air bag. The battery 4 is connected by an electrical line 5 with a terminal 6 of the cassette K that is designed as a fixed point. The electronic device 3 is connected to a terminal 8 of the cassette K by an electrical line 7. As shown in FIG. 1, the terminal 8 can be moved in the direction of the double arrow. In principle, it would also be possible for the terminal 8 to be stationary and for the terminal 6 to be movable.

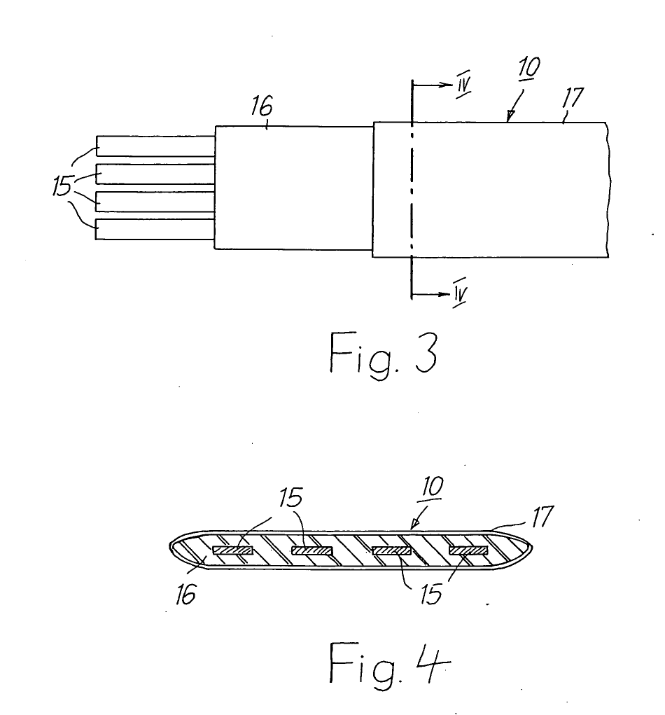

An FRL 10 with at least two electrical conductors is installed between the two terminals 6 and 8 within the cassette and between the stator and rotor of the cassette. The conductors are preferably realized as flat conductors. This embodiment of the FRL 10 is especially thin and therefore takes up very little space. In principle, however, the FRL 10 could also have round conductors. An example of the structure of the FRL 10 is shown in FIGS. 3 and 4. The nature of its connection or termination at the terminals 6 and 8 is not shown in detail. It is basically well known in different variants and is unimportant here.

As shown in FIG. 1, the FRL 10 can be arranged in the cassette K between the two terminals 6 and 8 as a winding body in several turns, i.e., in the manner of a spring barrel in a watch. Although the number of revolutions of a steering wheel is limited to about six, more than six turns should be provided for the FRL 10. The rotational movement of the terminal 8 installed on the rotor of the cassette K is then not very noticeable for a single turn of the FRL 10. Only the diameter of the winding body that comprises all of the turns of the FRL 10 is reduced or increased.

As shown in FIG. 2, the FRL 10 can also be realized in the cassette K as a winding body with two partial windings with opposite winding directions. A winding body of this type has an outer partial winding 11 and an inner partial winding 12. The two partial windings 11 and 12 are indicated by brackets. In the neutral position or installed position of the cassette K shown in FIG. 2, each partial winding 11, 12 consists of two to three turns. As has already been mentioned, in the two partial windings 11 and 12, the turns of the FRL 10 have opposite winding directions. They are connected with each other by an approximately U-shaped inversion point 13. A one-piece, ring-shaped guide element 14 that comprises the inversion point 13 is installed between the two partial windings 11 and 12.

The guide element 14 can be rotated about its center and can be easily moved in the circumferential direction of the cassette K, i.e., in the direction of the double arrow 9. It can be realized as a closed ring with a passage for the inversion point 13 of the FRL 10. However, it can also be an open ring that extends almost 360°. The guide element 14 is made of plastic, for example, polyoxymethylene. This makes it very light, so that it can be moved smoothly in the cassette K.

As FIGS. 3 and 4 show, the FRL 10 has four flat, approximately rectangular conductors 15, which are arranged parallel to each other and some distance apart in a sheath 16 of insulating material. The sheath 16 can be produced by an extruder. Examples of suitable materials for this type of sheath are polyimide, polyvinyl chloride, polyethylene and polyurethane. However, the sheath 16 can also consist of two laminating foils with the conductors 15 enclosed between them. Examples of suitable materials for the foils are polyethylene terephthalate and polyethylene naphthalate. Epoxy adhesives are preferably used as adhesion promoters. It is also possible for the FRL 10 to contain fewer or more than four conductors 15. The conductors 15 can also have a circular cross section. In addition, they can be realized as optical waveguides.

The FRL 10 is covered all the way around and over its entire length by a closed layer 17 of a crosslinked material with very good antifriction properties or good sliding ability. The layer 17 is applied by standard techniques, for example, by extrusion. Suitable materials are basically polymers whose sliding ability is suitably adjusted to predeterminable values. It is advantageous for the sliding friction between the FRL 10 and the plastic parts of the cassette K, i.e., the stator, rotor, and guide element, to have a value of 0.05 to 0.3μ. Fluoroplastics are especially suitable materials for the layer 17, especially, polytetrafluoroethylene and fluoroethylene propylene. It is advantageous for the thickness of the layer 17 to be 1-30 μm, and especially 15-25 μm. In a final step, its material is crosslinked or cured. This can be accomplished, for example, by IR radiation or UV radiation. The layer 17 is so thin that it does not adversely affect the weight and bending behavior of the FRL. However, it guarantees, on the one hand, smooth and quiet sliding of the FRL on the flat surfaces of the rotor and stator of the cassette K and, on the other hand, low sliding friction between the guide element 14 that is possibly present and especially the inner partial winding 12 of the FRL.

1. Device for signal transmission comprising:
two terminals, between which a flat ribbon line is arranged, which runs in turns, forms a winding body, is housed in an essentially circular cassette, and has at least two parallel, spaced conductors embedded in a sheath made of insulating material, which conductors can be connected to continuing lines at the two terminals and whose length is substantially greater than the distance between the two terminals, and in which device the cassette consists of a rotor that can rotate about the axis of the cassette, on which rotor one of the terminals is attached, and of a stationary stator, on which the other terminal is attached, between which the winding body of the flat ribbon line is arranged, wherein the sheath of the flat ribbon line is covered all the way around and over its entire length by a thin layer of a cross-linked insulating material with substantial antifriction properties, so that the sliding friction between the flat ribbon line and the plastic parts of the cassette is minimized.

2. Device in accordance with claim 1, wherein the sliding friction between the flat ribbon line (10) and the plastic parts of the cassette (K) is 0.05-0.3μ.

3. Device in accordance with claim 1, wherein the thickness of the layer (17) with good antifriction properties is 1-30 μm and preferably 15-25 μm.
